(19) United States
(12) Patent Application Publication
(10) Pub. No.: US 2024/0070732 A1
(43) Pub. Date: Feb. 29, 2024

(54) PET AND BUSINESS RATING SYSTEM AND METHODS

(71) Applicant: Protect Animals with Satellites, LLC, Upper Saddle River, NJ (US)

(72) Inventor: Terry Anderton, Hampton Falls, NH (US)

(21) Appl. No.: 18/458,260

(22) Filed: Aug. 30, 2023

Related U.S. Application Data
(60) Provisional application No. 63/402,561, filed on Aug. 31, 2022.

(51) Int. Cl. G06Q 30/0282

(52) U.S. Cl. CPC G06Q 30/0282

(57) ABSTRACT

A system and a method for rating a pet and business and tracking the pets within a business. The disclosed technology includes a system comprising a transceiver, one or more processors in communication with the transceiver, and a memory in communication with the one or more processors. The memory stores instructions that, when executed by the one or more processors, cause the system to receive data corresponding to a pet, determine, based at least in part on the data corresponding to the pet, whether to permit the pet to enter a premises, and output a notification to a user device indicative of whether the pet is permitted to enter the premises.

### RELATED APPLICATIONS

This application claims the benefit of priority under 35 U.S.C. § 119 to prior filed U.S. Provisional Patent Application No. 63/402,561, filed Aug. 31, 2022, the entire contents of which is hereby incorporated by reference as if set forth in full herein.

### FIELD OF THE INVENTION

The present invention relates generally to a pet and business rating system that assists with managing the animals within a particular business according to the particular business's guidelines.

### BACKGROUND OF THE INVENTION

Pets are increasingly becoming more integrated into the owner's lives. Products that improve safety and comfort for pets while traveling have been developed, smart collars that track animals and alert owners if the pet is lost, pet hoteling, and even certain businesses and restaurants that encourage (or at least don't discourage) owner's from bringing their pets along with them all help to integrate a pet into an owner's life. One of the problems of establishing a pet friendly establishment is that guidelines can vary between each business and behavior of certain animals/pet can be disruptive to other patrons or pets of patrons as well as the business establishment itself.

The present application seeks to provide solutions to the above problems as well as provide solutions and advantages that will become apparent to those skilled in the art.

### SUMMARY OF THE INVENTION

A system and a method for rating a pet and business and tracking the pets within a business. The disclosed technology includes a system comprising a transceiver, one or more processors in communication with the transceiver, and a memory in communication with the one or more processors. The memory stores instructions that, when executed by the one or more processors, cause the system to receive data corresponding to a pet, determine, based at least in part on the data corresponding to the pet, whether to permit the pet to enter a premises, and output a notification to a user device indicative of whether the pet is permitted to enter the premises.

The data corresponding to the pet can be received from a smart collar. The data corresponding to the pet can be automatically transmitted to the transceiver from the smart collar when the smart collar enters a geofenced area. The data corresponding to the pet can be received from a smart phone. The smart phone can be configured to transmit the data corresponding to the pet to the transceiver in response to the smart phone having scanned a quick-response (QR) code.

The instructions, when executed by the one or more processors, can further cause the system to determine whether the data corresponding to the pet is indicative of the pet having a rating above a predetermined threshold, and in response to determining that the rating is above the predetermined threshold, output a notification to the user device indicative of the pet being permitted to enter the premises. The instructions, when executed by the one or more processors, can further cause the system to track a position of the pet within the premises. The instructions, when executed by the one or more processors, can further cause the system to generate a seating assignment based at least in part on the data corresponding to the pet. The instructions, when executed by the one or more processors, can further cause the system to output instructions to a smart collar worn by the pet to keep the pet a predetermined distance away from another pet or patron on the premises. The instructions, when executed by the one or more processors, can further cause the system to output instructions to a smart collar worn by the pet to keep the pet within an assigned geofenced area within the premises.

The instructions, when executed by the one or more processors, further cause the system to determine whether the data corresponding to the pet is indicative of the pet having a rating above a predetermined threshold, and in response to determining that the rating is below the predetermined threshold, output a notification to the user device indicative of the pet not being permitted to enter the premises.

The instructions, when executed by the one or more processors, can further cause the system to output one or more guidelines to a user device, the guidelines corresponding to one or more predetermined requirements corresponding to the premises.

The instructions, when executed by the one or more processors, can further cause the system to receive a response from the user device, the response indicative of a user having agreed to the guidelines. The instructions, when executed by the one or more processors, can further cause the system to output a notification to the user device indicative of the pet being permitted to enter the premises.

The instructions, when executed by the one or more processors, can further cause the system to determine whether a predetermined capacity of pets on the premises has been met, and in response to determining that the predetermined capacity of pets on the premises has been met, output a notification to the user device indicative of the pet not being permitted to enter the premises until the predetermined capacity of pets is no longer met.

The instructions, when executed by the one or more processors, can further cause the system to receive data corresponding to one or more patrons present on the premises, the data corresponding to one or more patrons comprising a preference of the one or more patrons. Wherein, determining whether to permit the pet to enter the premises can be based on the preference of the one or more patrons.

The disclosed technology includes a system comprising a transceiver, one or more processors in communication with the transceiver, and a memory in communication with the one or more processors and storing instructions. The instructions, when executed by the one or more processors, can cause the system to receive data corresponding to a pet and determine whether a predetermined capacity of pets on a premises has been met. The instructions can further cause the system to determine, based at least in part on the data corresponding to the pet and whether the predetermined capacity has been met, whether to permit the pet to enter the premises and output a notification to a user device indicative of whether the pet is permitted to enter the premises.

The predetermined capacity can be based on a type of animal and determining whether the predetermined capacity of pets on a premises has been met can comprise determining whether a predetermined capacity of a type of animal has been met.

The data corresponding to the pet can be received from a smart collar. The data corresponding to the pet can be automatically transmitted to the transceiver from the smart collar when the smart collar enters a geofenced area.

### BRIEF DESCRIPTION OF THE DRAWINGS

The foregoing and other objects, features, and advantages of the invention will be apparent from the following description of the disclosed technology, as illustrated in the accompanying drawings in which like reference characters refer to like elements throughout the different views. The drawings are not necessarily to scale, emphasis instead being placed upon illustrating the principles of the invention.

FIG. 1 illustrates an example of the pet and business rating system, according to the disclosed technology.

FIG. 2 illustrates a flow chart of the pet and business rating system, specifically showing the steps of an individual arriving at a business, according to the disclosed technology.

FIG. 3 illustrates a flow chart of the pet and business rating system, specifically showing the steps of an individual arriving at a food establishment, according to the disclosed technology.

FIG. 4 illustrates a block diagram of the pet and business rating system, specifically showing the inputs available from the welcome screen, according to the disclosed technology.

FIG. 5 illustrates a block diagram of the pet and business rating system, specifically showing the steps of registering a business or food establishment, according to the disclosed technology.

FIG. 6 illustrates a block diagram of the pet and business rating system, specifically showing the steps of registering an individual or a pet, according to the disclosed technology.

FIG. 7 illustrates a diagram of the pet and business rating system, specifically showing the inputs and outputs of logging into the system, according to the disclosed technology.

FIG. 8 illustrates a block diagram of the pet and business rating system, specifically showing the inputs and outputs of the guidelines screen, according to the disclosed technology.

FIG. 9 illustrates a block diagram of the pet and business rating system, specifically showing the inputs and outputs for the QR code screen, according to the disclosed technology.

FIG. 10 illustrates a block diagram of the pet and business rating system, specifically inputs and outputs of the warning/alert screen, according to the disclosed technology.

FIG. 11 illustrates a block diagram of the pet and business rating system, specifically the inputs and outputs of the rating screen, according to the disclosed technology.

FIG. 12 illustrates a screen view of the pet and business rating system, specifically the map view of a business, according to the disclosed technology.

FIG. 13 illustrates a screen view of the pet and business rating system, specifically the map view of a food establishment, according to the disclosed technology.

### DETAILED DESCRIPTION OF THE INVENTION

Contemplated herein is a pet and business rating system for communicating with potential patrons about the current status of the animals located in a business. In addition, a method for determining an appropriate seating arrangement in food service establishments is also disclosed with respect to the animals already in the food service establishment.

In some instances, patrons arrive at a pet friendly business or food establishment to find that they will be sitting near a dog, for example, which makes the patron uncomfortable or maybe they are allergic. Either way, had the patron known ahead of time, the patron and the food establishment could have planned to avoid this disastrous scenario. The pet and business rating system provides a mechanism for preplanning visits to pet friendly establishments.

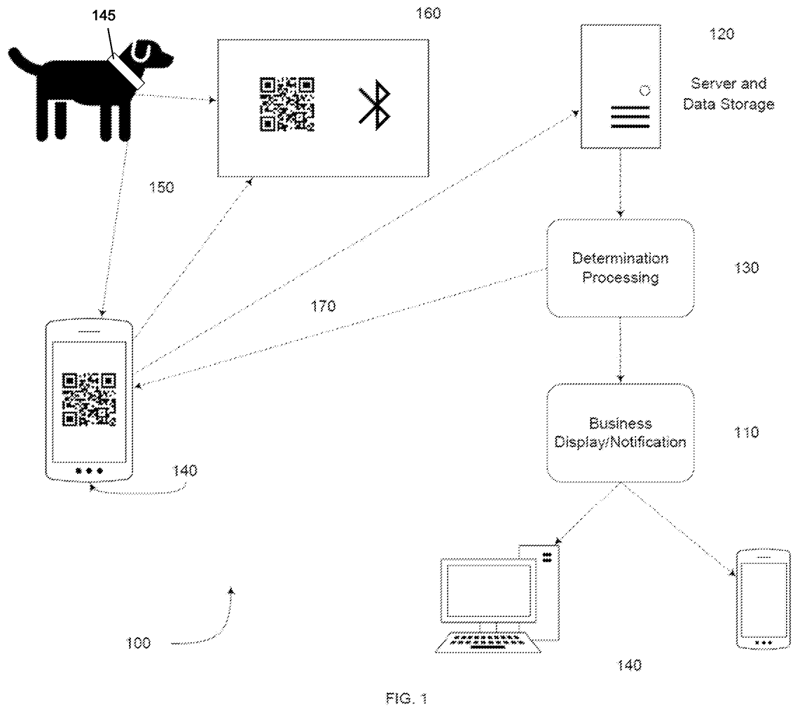

In accordance with these concepts, the system 100 as contemplated can include a server and data storage 120 (e.g., a memory), determination processing 130 (e.g., one or more processors), business display 110, user interface 140 capable of receiving and transmitting signals 170, and a wireless transceiver 160 capable of receiving and transmitting signals 150, as shown in FIG. 1. The user interface 140 can be a smart phone, a tablet, a computer, or other smart electronic device comprising a display. The wireless transceiver can be configured to receive and transmit signals 150 directly to the determination processing 130, the server and data storage 120, and/or the user interface 140.

In an exemplary embodiment, the pet and business rating system 100 comprises a wireless transceiver 160, a user interface 140, server and data storage 120, determination processing 130, and business display 110; wherein an animal smart collar 145 transmits a signal 150 to the wireless transceiver 160 and the wireless transceiver transmits the signal 170 (e.g., over the internet, a wireless network, etc.) to the server and data storage 120. The server and data storage 120 can then communicate with the determination processing 130 and the determination processing 130 can then transmit an output to the business display 110 and/or the user interface 140. The signal 150 from the animal smart collar 145 can be any wireless signal capable of being transmitted from a smart collar 145 and received by the transceiver 160 and/or the user interface 140. For example, Bluetooth, Wi-Fi, RFID, GPS, etc.

In an alternate embodiment, the pet and business rating system 100 comprises a wireless transceiver 160, a user interface 140, server and data storage 120, determination processing 130, and business display 110; wherein a user scans a quick-response (QR) code with their user interface 140 (e.g., the user's smart phone) and the user interface 140 then transmits a signal over the internet 170 to the server and data storage 120 and determination processing 130. The determination processing 130 can then output a signal to the business display 110 and user interface 140.

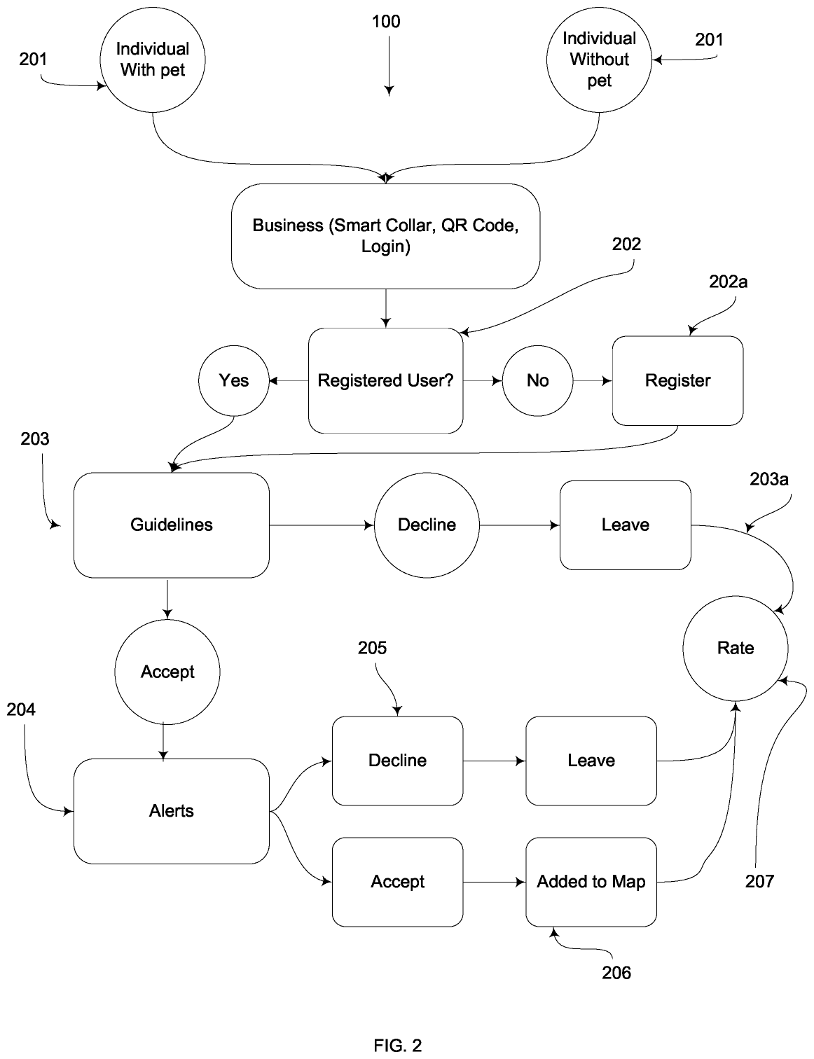

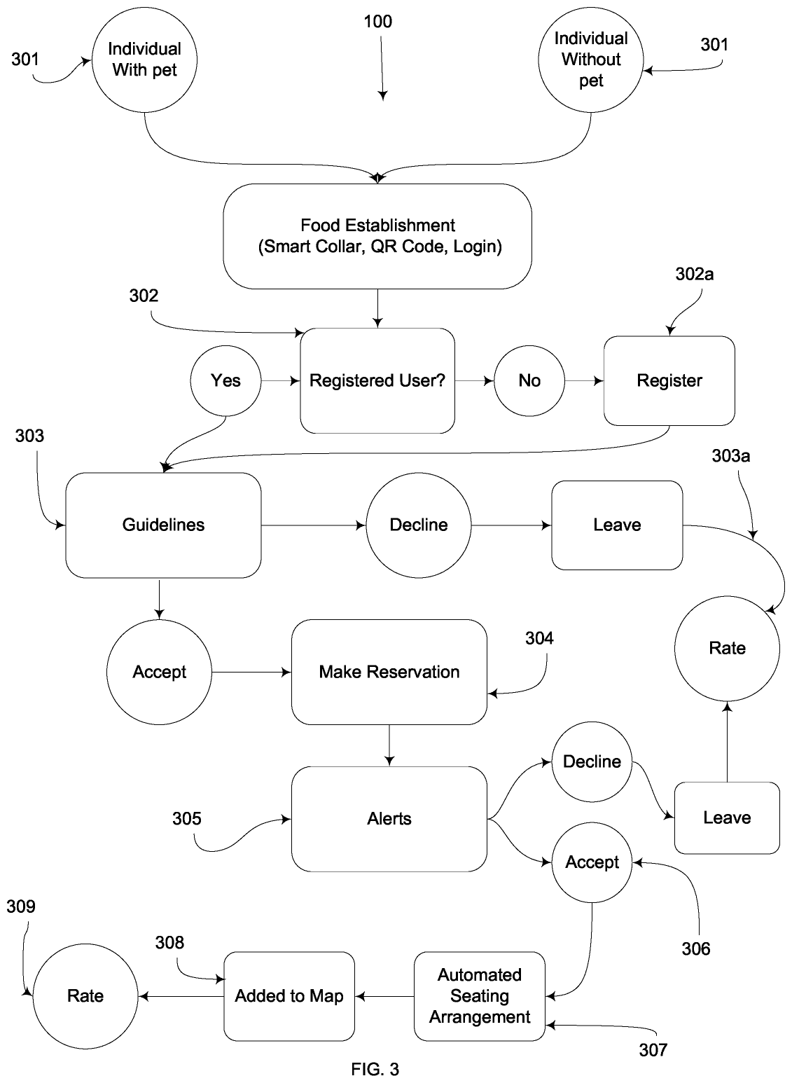

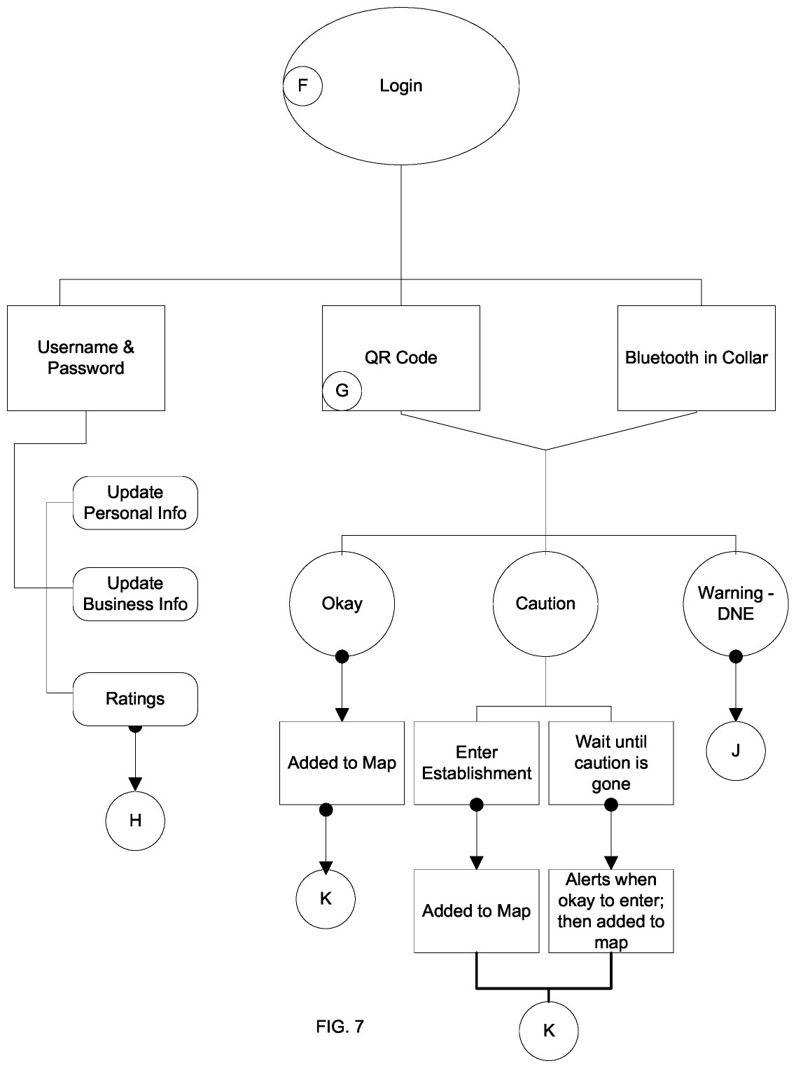

FIGS. 2-3 show flow charts of a method of using the pet and business rating system 100. Step 201 comprises of an individual with or without a pet arriving at a business. Individuals with a pet who is wearing a smart collar 145 device can be logged into the system automatically as pending arrival once they are within a geofence area. For example, a geofence can be set a predetermined area around the business and the smart collar 145 can be configured to automatically output a signal to the business (e.g., the server and data storage 120) when the smart collar 145 enters the geofence. The smart collar 145 device can connect to pet and business rating system 100 via Bluetooth, Wi-Fi, GPS, RFID, or other similar connection method. Other individuals can log in to the system via a QR code placed outside the business or with a username and password (e.g., login to an account associated with the business, see FIG. 7).

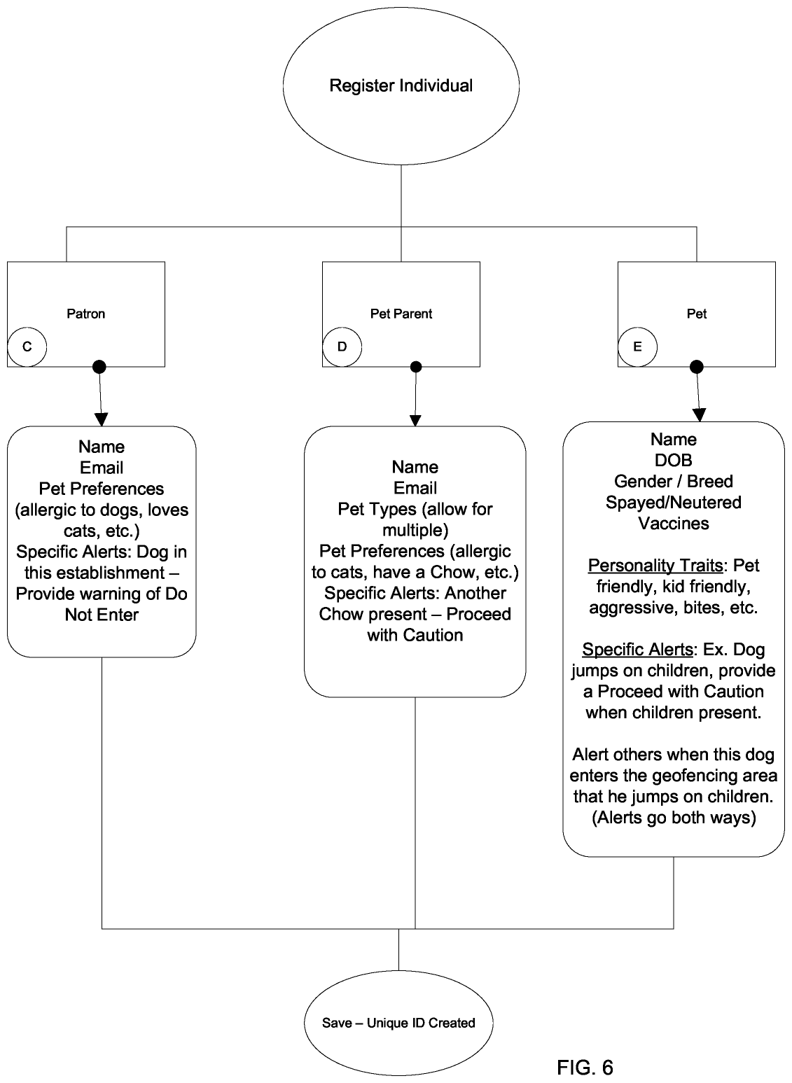

Step 202 comprises of verifying individual is a registered user and pet is a registered pet (if applicable). If the individual is not a registered user, then step 202a comprises of registering the individual and registering the pet if applicable (see FIG. 6).

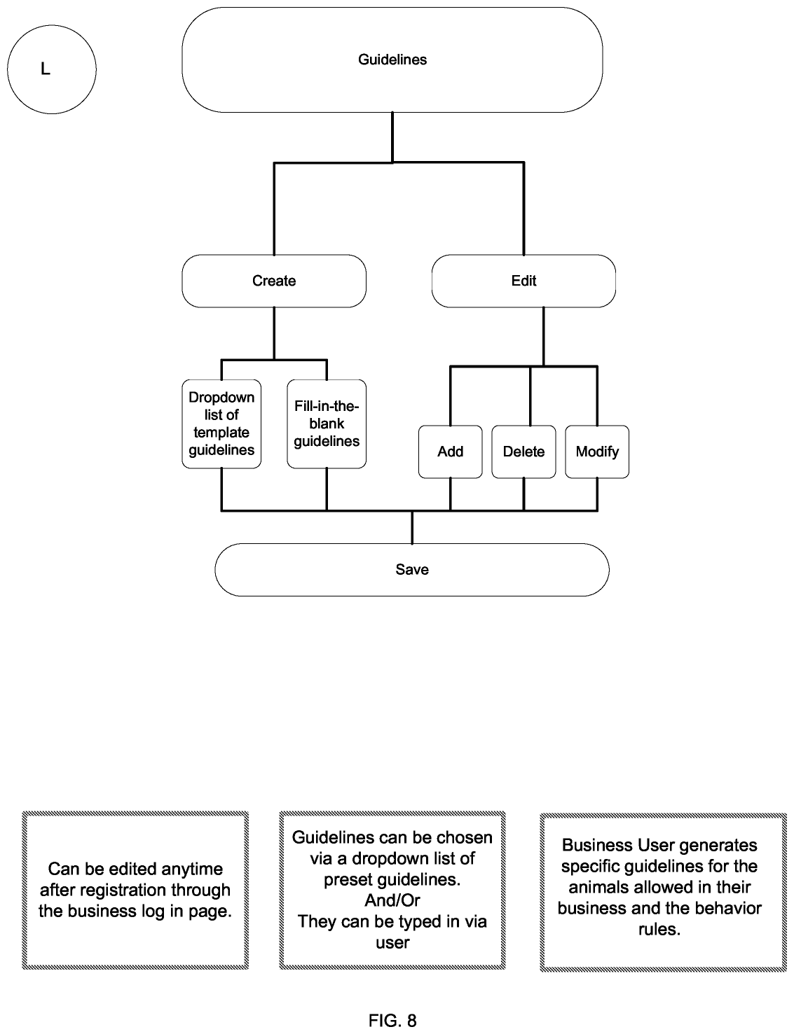

Step 203 comprises of providing guidelines to individual (e.g., to an individual's smart phone, tablet, etc.) and prompting the individual to accept or decline the guidelines before moving on to next step. If a user declines the guidelines as set forth by the business, then the user cannot enter the business (e.g., automatic doors will not open for the user, a security guard or other employee can prevent the user from entering, or a notification can simply be output to the user's smart phone instructing him or her to not enter the business). Step 203a comprises of presenting the user with a rating screen once the user declines the guidelines (see FIG. 8).

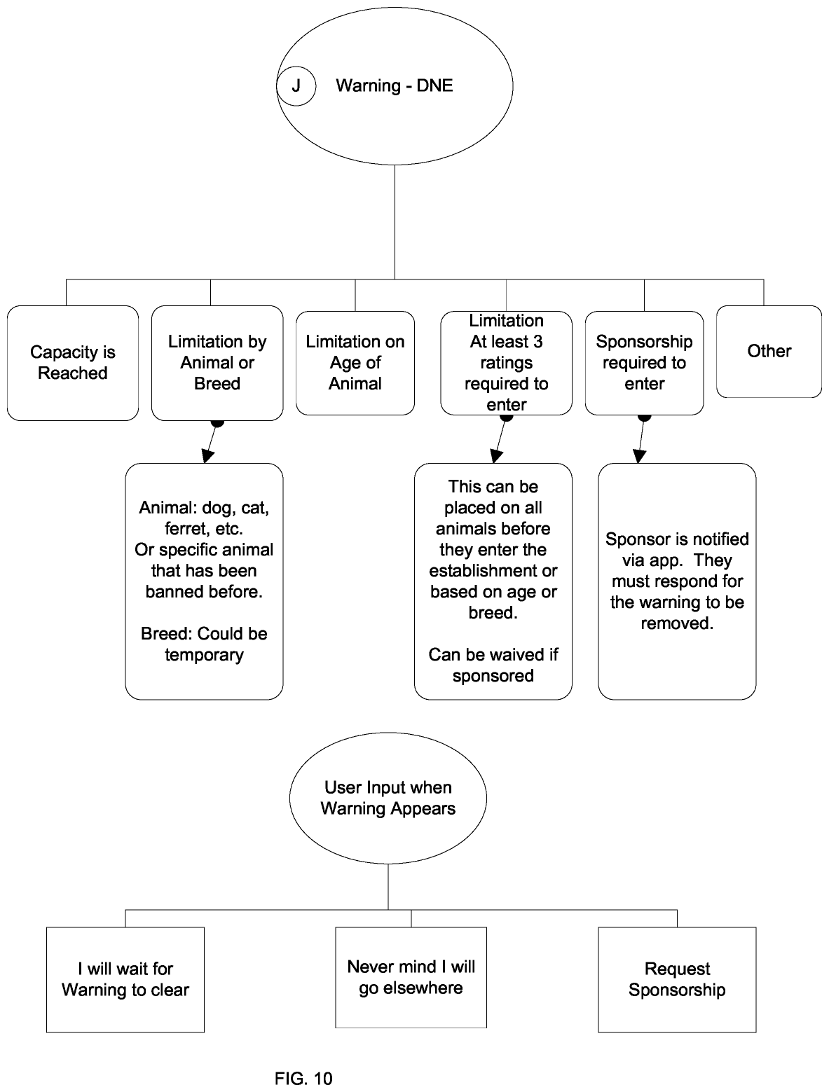

Step 204 comprises of providing alerts to the individual based on his or her profile, the pet's profile, the business's profile, or any other individual's profile who is already in the business (see FIG. 10). This is a determination step. Step 204a comprises of providing an alert to the business that an individual is pending arrival. The pet and business rating system 100 is meant to be fully automated; however, users can override the automated prompts and proceed with a manual entry mode. In Step 204b, the business owner has the option to override the automated steps, e.g., allowing a pet owner and his or her pet to enter the business after they received a warning alert that the pet did not have a high enough star rating.

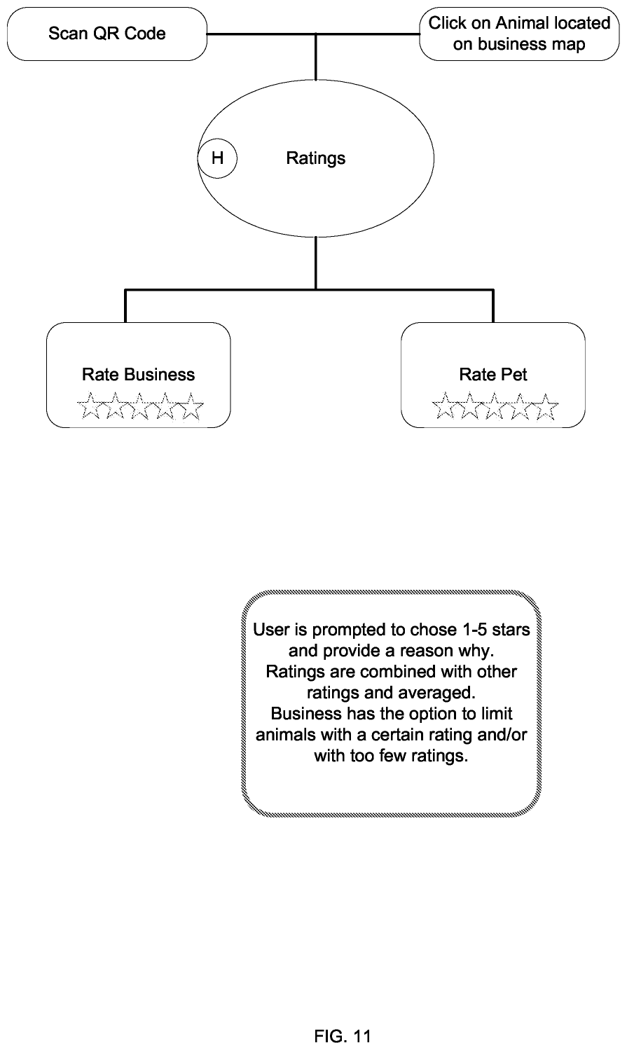

Step 205 comprises of an individual accepting or declining the alert. If a user declines the alert, then he or she cannot enter the business. Step 205a comprises of presenting the user with a rating screen once the user declines the alert (see FIG. 11).

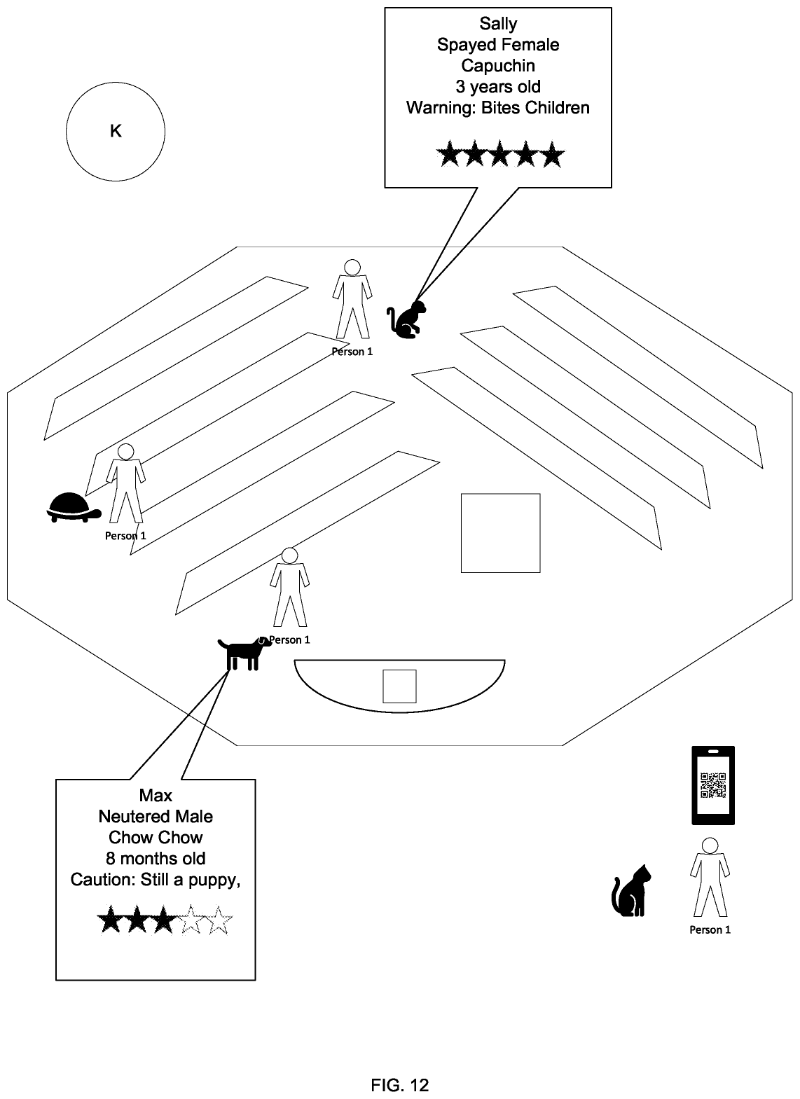

Step 206 comprises of adding individual and pet (if applicable) to interactive map of business (see FIG. 12).

Step 207 comprises of rating a pet or business from the interactive map. Individual can click on the icon of the business to rate the business or click on the pet represented on the map to rate the pet (see FIG. 12). Once a rating is added to the business or pet, that rating is combined with all other ratings for that business or pet and averaged.

Step 208 (not shown in FIG. 1) comprises of individual leaving the business and being removed from interactive map.

FIG. 3 shows a flow chart of an alternate method of using the pet and business rating system 100. Step 301 comprises of an individual with or without a pet arriving at a food establishment. Individuals with a pet who is wearing a smart collar 145 device will be logged into the system automatically as pending arrival once they are within the geofence area (as described previously). The smart collar 145 device can connect to pet and business rating system 100 via Bluetooth, Wi-Fi, GPS, RFID, or other similar connection method. Other individuals can log in to the system via a QR code placed outside the food establishment or with a username and password (see FIG. 7).

Step 302 comprises of verifying individual is a registered user and pet is a registered pet if applicable. If the individual is not a registered user, then step 302a comprises of registering the individual and registering the pet if applicable (see FIG. 6).

Step 303 comprises of providing guidelines to individual and prompting him or her to accept or decline before moving on to next step. If a user declines the guidelines as set forth by the food establishment, then he or she cannot enter the food establishment (e.g., automatic doors will not open for the user, a security guard or other employee can prevent the user from entering, or a notification can simply be output to the user's smart phone instructing him or her to not enter the business). Step 303a comprises of presenting the user with the rating screen once the user declines the guidelines (see FIG. 8). As shown in FIG. 8, the guidelines can be configurable such that the business or food establishment can have its own unique requirements as desired. For example, new guidelines can be created (either from a drop down list of template guidelines or by a fill-in-the-blank guidelines) or existing guidelines can be edited (added, deleted, modified) and all changes to the guidelines can be saved for implementation.

Step 304 comprises of making a reservation in the system. Step 305 comprises of providing alerts to the individual based on his or her profile, his or her pet's profile, the food establishment's profile, or any other individual's profile who is already in the food establishment (see FIG. 10). Step 305a comprises of providing an alert to the food establishment that an individual is pending arrival. The pet and business rating system 100 is meant to be fully automated; however, users can override the automated prompts and proceed with a manual entry mode. In Step 305b, the business owner has the option to override the automated steps, e.g., allowing a pet owner and his or her pet to enter the food establishment after they received a warning alert that the pet did not have a high enough star rating.

Step 306 comprises of individual accepting or declining the alert. If a user declines the alert, then he or she and the pet cannot enter the food establishment (e.g., automatic doors will not open for the user, a security guard or other employee can prevent the user from entering, or a notification can simply be output to the user's smart phone instructing them to not enter the business). Step 306a comprises of presenting the user with the rating screen once the user declines the alert (see FIG. 11).

Step 307 comprises of creating an automated seating arrangement based on limitations and preferences. For example, the method can include automatically generating a seating arrangement based on pets present at the food establishment, a user's preference, and/or a pet's rating. The pet's rating can include ratings provided by businesses, food establishments, and/or other users that have previously had encounters with the animal.

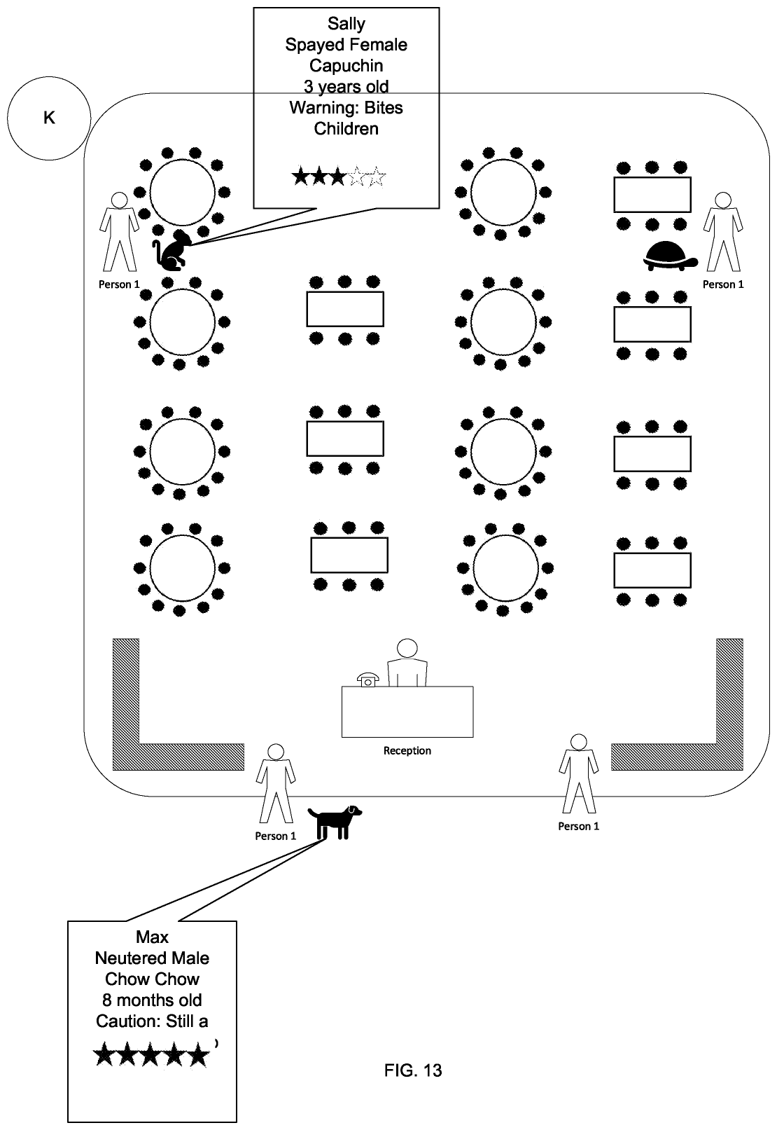

Step 308 comprises of adding individual and pet (if applicable) to interactive map of food establishment (see FIG. 13).

Step 309 comprises of rating a pet or business from the interactive map. Individual can click on the icon of the business to rate the business or click on the pet represented on the map to rate the pet (see FIG. 13). Once a rating is added to the business or pet, that rating is combined with all other ratings for that business or pet and averaged.

Step 310 (not shown) comprises of individual leaving the food establishment and being removed from interactive map.

Alerts are limitations that are automatically generated based on the inputs of the pet owner, patron, or business owner. For example, if the business owner doesn't want more than 3 dogs in the business at a time, the owner can set up a caution alert for the 3^{rd} dog to enter the business and a warning alert for the 4^{th} dog. The warning alert, for example, can indicate that the 4^{th} dog should not enter the business or that the owner would prefer that the 4^{th} dog wait until another dog leaves the business before the 4^{th} dog enters. Another example would be if a patron is allergic to cats and cannot be in an establishment with a cat. Other examples include, type of animal, allergies of other patrons, allergies of other animals, sponsorship requirement, etc. (see FIG. 10).

As another example, there can be at least three variations of alerts (e.g., the alerts mentioned in the steps above) that can be based on the profiles of the pending individual, pending pet, business or food establishment, and/or the profile of the individuals and/or pets already in the business or food establishment. The three alerts are okay, caution, and warning. An okay alert tells the individual that he or she and the pet are cleared to enter the business or food establishment. A caution alert lets the individual know they should proceed with caution. An example would be a direction to stay in one section of the store so as not to interact with a puppy who isn't good with that individual's pet. The individual must acknowledge the alert to enter the business or food establishment.

A warning alert lets the individual know he or she and/or the pet cannot enter the business or food establishment and must clear the warning prior to entry. The individual can follow the directions and clear the warning, or the warning can be cleared by the business owner. This is based on the business owner's discretion. For example, if the business owner has a requirement that the pet must have a 4-star rating prior to entering and the current pet attempting to enter the business is at 3½-stars, the business owner can override the warning and admit the pet owner and pet or patron.

These types of limitations are meant to be specific to each business based on the business owner's discretion. Example limitations include business capacity almost at limit, pet owner's animal cannot be around an animal currently in the business, or a rating threshold must be met. A person skilled in the art can envision other limitations that are within the present scope of the invention.

Ratings, referred to above in step 207 and 309, can be completed by an individual or by the business. Once a rating is completed for a pet or a business, the raw data is combined with the other ratings pertaining to that pet or that business and averaged, providing an updated overall rating score. User can click on the number of stars (1-5) they wish to rate the business or pet and/or fill in specific information about how they wish to rate the business or pet (see FIG. 11).

Some ratings can result in a limitation being added to the profile of the business or pet being reviewed. For example, “Sally, the Capuchin, threw food at me as I walked by her. I don't want to be around this animal again.” A limitation will be added to the user who created the rating to alert them if Sally is ever in the business again when they arrive. The business will also be alerted to the new limitation.

The system can be provided with a user portal 140 or web app that can present an interactive map to the user. It will also be understood that the user portal 140 can be presented to the user or interacted with by the user via an application on a mobile device or using an online portal. As discussed in some detail above, the system will include a user platform, such as an application, that can be configured to receive input from a user. It will be understood that the application/user platform can be accessed through mobile devices, web portals, or any number of suitable means. It will be understood that the platform is operable to define at least one permitted zone where the pet is permitted to reside and at least one restricted zone where the pet is restricted from entering. This can be achieved by defining or drawing boundaries, for example on a map.

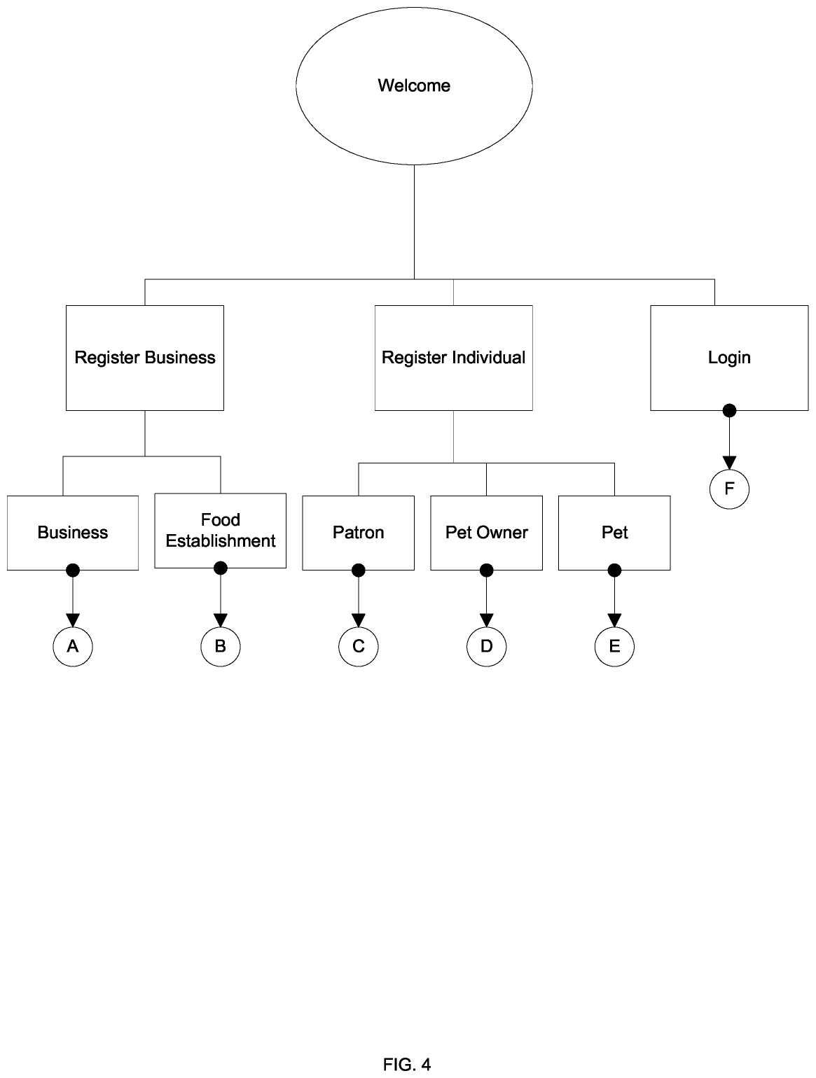

FIG. 4 details a flow chart of the welcome screen and the options to either register a business, register an individual, or login. A business can further be broken down into a business or food establishment. The individual registration screen has three options: patron, pet owner, or pet. A patron is someone who is intending to enter the business or food establishment without a pet. A pet owner is someone who is intending to enter the business or food establishment with a pet. This can be any individual with a pet and not necessarily the pet's documented owner. For example, a pet sitter would be considered a pet owner for the purposes of this system.

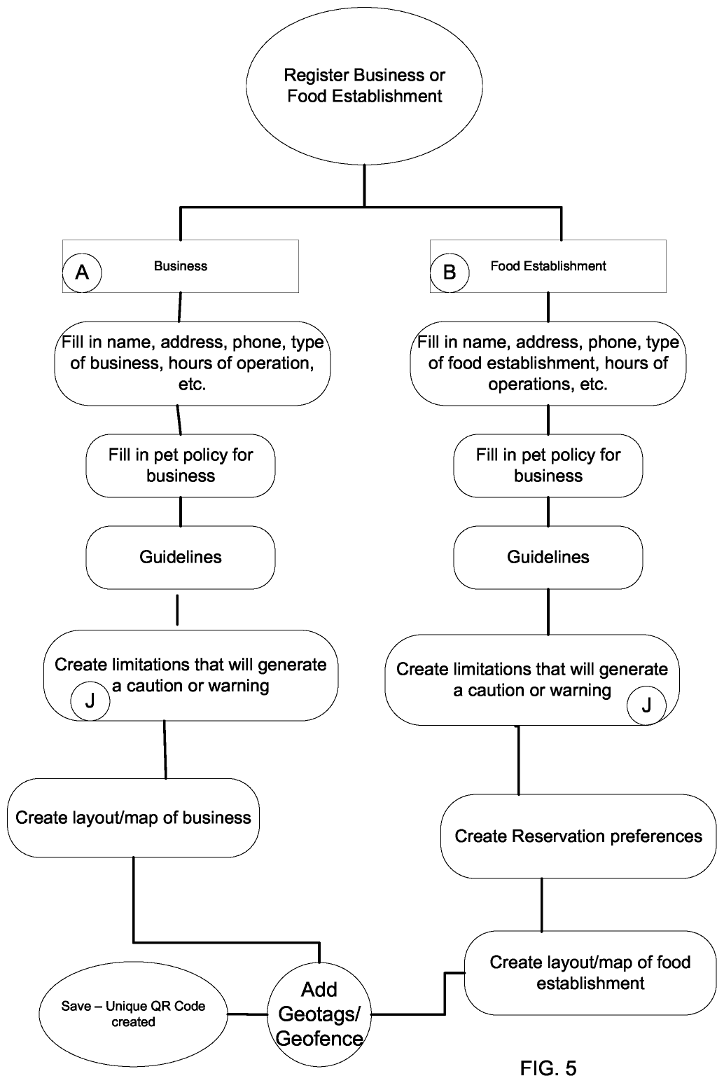

FIG. 5 is a flow chart detailing the method of how to register a business or food establishment via the pet and business rating system. The method can include selecting whether you want to register a business (A) or a food establishment (B). Both options can include options to provide details of the business or the food establishment. For example, the method can include options for providing the name, address, phone, type of business (or food establishment), hours of operation, etc. to the system. The method can further include options for providing a pet policy, guidelines, and limitations that will generate a caution or warning. If information for a business is being provided, the method can include creating a layout or map of the business. If information for a food establishment is being provided, the method can include creating reservation preferences and a layout/map of the food establishment. The layout/map of the food establishment, for example, can include a map of the tables and seat options in the food establishment so that a seating arrangement can be generated. The method can include adding a geotag/geofence so that all or certain areas of the business can be marked and the smart collar can be configured to take certain actions based on the geotags/geofence.

FIG. 6 is a flow chart detailing the method of how to register and individual via the pet and business rating system. For example, the method can include selecting to register a patron (C) and providing a name, email, pet preference (allergies, preferences for certain animals, etc.), specific alerts (e.g., alert me when a dog is in the establishment and/or provide a warning to a user attempting to enter the business with a dog), etc. The method can include saving the provided information and creating a unique patron identification (ID).

The method shown in FIG. 6 can further include selecting to register a pet parent (D) and providing a name, an email, a pet type (could allow for multiple pet types), pet preferences (allergies, type of owned or preferred pets, etc.), specific alerts (e.g., alert me when another chow is present), etc. The method can include saving the provided information and creating a unique pet parent identification (ID).

The method shown in FIG. 6 can further include selecting to register a pet (E) and providing a name, date of birth, gender, breed, whether the pet is spayed or neutered, vaccine information, personality traits (e.g., pet friendly, kid friendly, aggressive, bites, etc.), specific alerts (e.g., dog jumps on children, provide a “proceed with caution” alert when children are present), an option to alert others when a specific pet enters the geofence (e.g., alert others that a particular dog jumps on children when the dog enters the geofence) etc. The method can include saving the provided information and creating a unique pet identification (ID).

FIG. 7 is a flow chart detailing the method of using the login screen via the pet and business rating system. For example, the method show in FIG. 7 can represent information presented to an owner or employee of a business or food establishment when an animal is determined to be present. The method can include an option to enter username and password for the business or food establishment and options to update personal information, business information, and/or to view and respond to ratings (H—as shown in FIG. 11) (e.g., ratings provided by patrons of the business or food establishment). For example, a user can be prompted to select a number of stars representative of a rating of the business or food establishment and provide a reason for the rating. Ratings of the business, food establishment, and/or pet can then be aggregated and a rating score can be assigned to the business, food establishment, and/or pet (e.g., 4.5 stars). The business or food establishment can include guidelines that prevent pets below a specific rating from entering the business or food establishment.

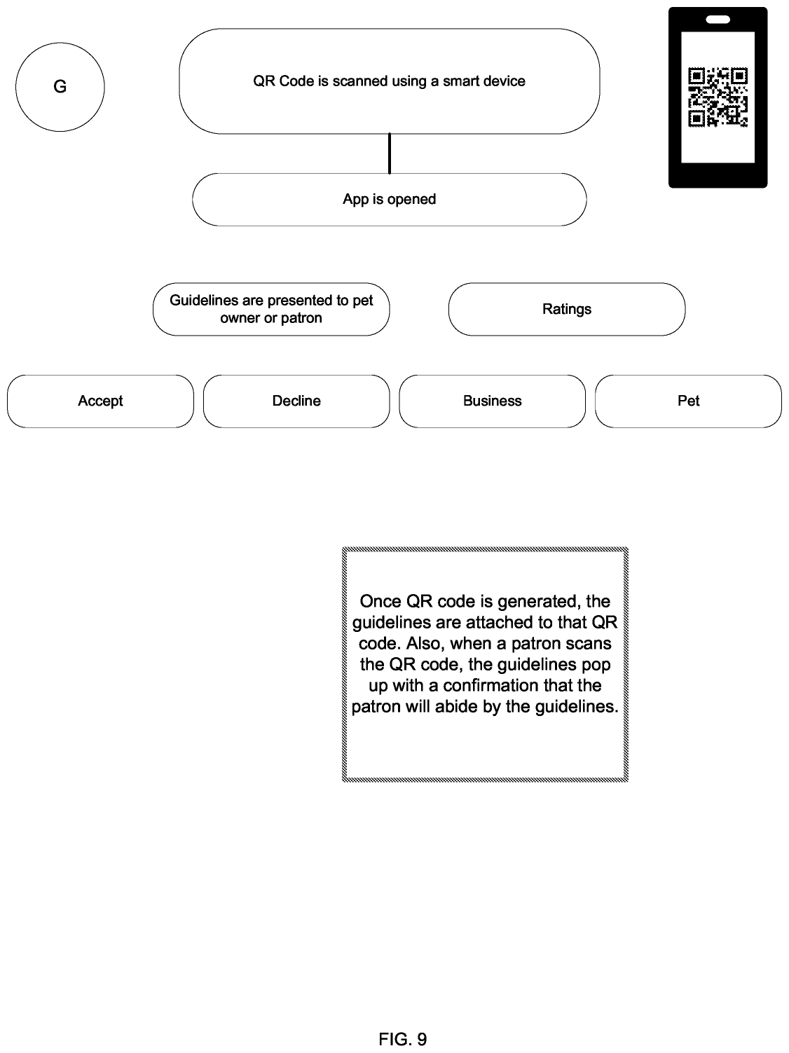

The method shown in FIG. 7 can further include connecting or receiving information about a pet at or near the business or food establishment by a user having scanned a QR code (G) and/or by having detected the present of the pet via the smart collar. For example, as shown in FIG. 9, once a user scans a QR code, a menu can appear on a user interface 140 (e.g., a user's smart phone, tablet, computer). The menu can include guidelines, ratings, options to accept or decline a message or the guidelines, and options to select information about the business and/or a pet.

The method shown in FIG. 7 can include determining whether the pet is permitted to enter the business or food establishment, whether to output a caution alert or a warning alert. If the pet is cleared to enter, the method can including adding the pet to the map as shown in FIG. 12 (for a business) or FIG. 13 (for a food establishment). As shown in FIGS. 12 and 13, the disclosed technology can include maps configured to show a layout of the business or food establishment as well as the location of other patrons or pets present in the establishment. The user and/or business can then view the location of each of the patrons and/or pets and make decisions based on knowing where the patrons and/or pets are located. In a non-limiting example, the system can be configured to assign an area or a seat to a particular pet in order to keep that pet away from other pets present in the establishment or patrons in the establishment. If the pet is wearing a smart collar, the system can be configured to output instructions to the collar to keep the pet away from another pet or patron. For example, the smart collar can be configured to keep the pet a predetermined distance away from other pets or patrons or to generate a geofence to keep the pet in a particular area of the establishment.

As shown in FIG. 7, if the system determines that a caution alert should be output, the method can include outputting a notification to allow the pet to enter the establishment or instructions to wait until the reason for the caution is gone (e.g., another pet present in the establishment has left). Determining whether the pet can enter the establishment can be automatic (e.g., based on a rating of the pet) or can be manually selected by an owner or employee of the business. If the pet is to wait until the caution is cleared, the method can include outputting another alert when the caution has cleared. In either example, the method can include adding the pet to the map as shown in FIG. 12 (for a business) or FIG. 13 (for a food establishment) once the pet is permitted to enter.

The method shown in FIG. 7 can further include outputting a warning alert and providing instructions for a pet to not enter an establishment. The method can further include providing reasons for why the pet is not permitted to enter the establishment as shown in FIG. 10. For example, as shown in FIG. 10, the reasons for why the pet is not permitted to enter the establishment can include the capacity is reached, the establishment has limits on the type of animal or breed of animal, the specific animal has been banned from the establishment before, a limitation on age of animal, a limitation based on the rating or the number of ratings of the animal, whether sponsorship is required (e.g., a person can be designated as a sponsor for a particular animal), or other reasons that may be determined by the business or food establishment.

As shown in FIG. 10, when the user receives a warning alert, the user can provide a response to the warning such as an indication that the user will wait until the warning clears, an indication that the user will go elsewhere, or a request for a sponsorship (e.g., an employee or other person can be designated as a sponsor to help ensure the animal maintains good behavior).

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A system comprising:
a transceiver;
one or more processors in communication with the transceiver; and
a memory in communication with the one or more processors and storing instructions that, when executed by the one or more processors, cause the system to:
receive data corresponding to a pet;
determine, based at least in part on the data corresponding to the pet, whether to permit the pet to enter a premises; and
output a notification to a user device indicative of whether the pet is permitted to enter the premises.

2. The system of claim 1, wherein the data corresponding to the pet is received from a smart collar.

3. The system of claim 2, wherein the data corresponding to the pet is automatically transmitted to the transceiver from the smart collar when the smart collar enters a geofenced area.

4. The system of claim 1, wherein the data corresponding to the pet is received from a smart phone.

5. The system of claim 4, wherein the smart phone is configured to transmit the data corresponding to the pet to the transceiver in response to the smart phone having scanned a quick-response (QR) code.

6. The system of claim 1, wherein the instructions, when executed by the one or more processors, further cause the system to:
determine whether the data corresponding to the pet is indicative of the pet having a rating above a predetermined threshold; and
in response to determining that the rating is above the predetermined threshold, output a notification to the user device indicative of the pet being permitted to enter the premises.

7. The system of claim 6, wherein the instructions, when executed by the one or more processors, further cause the system to track a position of the pet within the premises.

8. The system of claim 7, wherein the instructions, when executed by the one or more processors, further cause the system to generate a seating assignment based at least in part on the data corresponding to the pet.

9. The system of claim 7, wherein the instructions, when executed by the one or more processors, further cause the system to output instructions to a smart collar worn by the pet to keep the pet a predetermined distance away from another pet or patron on the premises.

10. The system of claim 7, wherein the instructions, when executed by the one or more processors, further cause the system to output instructions to a smart collar worn by the pet to keep the pet within an assigned geofenced area within the premises.

11. The system of claim 1, wherein the instructions, when executed by the one or more processors, further cause the system to:
determine whether the data corresponding to the pet is indicative of the pet having a rating above a predetermined threshold; and
in response to determining that the rating is below the predetermined threshold, output a notification to the user device indicative of the pet not being permitted to enter the premises.

12. The system of claim 1, wherein the instructions, when executed by the one or more processors, further cause the system to output one or more guidelines to a user device, the guidelines corresponding to one or more predetermined requirements corresponding to the premises.

13. The system of claim 12, wherein the instructions, when executed by the one or more processors, further cause the system to receive a response from the user device, the response indicative of a user having agreed to the guidelines.

14. The system of claim 13, wherein the instructions, when executed by the one or more processors, further cause the system to output a notification to the user device indicative of the pet being permitted to enter the premises.

15. The system of claim 1, wherein the instructions, when executed by the one or more processors, further cause the system to:
determine whether a predetermined capacity of pets on the premises has been met; and
in response to determining that the predetermined capacity of pets on the premises has been met, output a notification to the user device indicative of the pet not being permitted to enter the premises until the predetermined capacity of pets is no longer met.

16. The system of claim 1, wherein the instructions, when executed by the one or more processors, further cause the system to receive data corresponding to one or more patrons present on the premises, the data corresponding to one or more patrons comprising a preference of the one or more patrons, and
wherein, determining whether to permit the pet to enter the premises is further based on the preference of the one or more patrons.

17. A system comprising:
a transceiver;
one or more processors in communication with the transceiver; and
a memory in communication with the one or more processors and storing instructions that, when executed by the one or more processors, cause the system to:
receive data corresponding to a pet;
determine whether a predetermined capacity of pets on a premises has been met;
determine, based at least in part on the data corresponding to the pet and whether the predetermined capacity has been met, whether to permit the pet to enter the premises; and
output a notification to a user device indicative of whether the pet is permitted to enter the premises.

18. The system of claim 17, wherein the predetermined capacity is based on a type of animal and determining whether the predetermined capacity of pets on a premises has been met comprises determining whether a predetermined capacity of a type of animal has been met.

19. The system of claim 17, wherein the data corresponding to the pet is received from a smart collar.

20. The system of claim 19, wherein data corresponding to the pet is automatically transmitted to the transceiver from the smart collar when the smart collar enters a geofenced area.
